(19) United States
(12) Patent Application Publication
(10) Pub. No.: US 2007/0155382 A1
(43) Pub. Date: Jul. 5, 2007

(54) Scalable, indirect-routing method and system for mobile number portability

(75) Inventor: John Yue Jun Jiang, Danville, CA (US)

Correspondence Address: ARENT FOX PLLC, 1050 CONNECTICUT AVENUE, N.W., SUITE 400, WASHINGTON, DC, 20036, US

(73) Assignee: Roamware, Inc.

(21) Appl. No.: 11/600,906

(22) Filed: Nov. 17, 2006

Related U.S. Application Data
(60) Provisional application No. 60/737,956, filed on Nov. 17, 2005.

(51) Int. Cl. H04Q 7/20

(52) U.S. Cl. 455/433

(57) ABSTRACT

A system and method for providing mobile number portability. The system includes a first Mobile Number Portability Node (MNPN) coupled to a first network. The first MNPN receives a first query for one or more ported-out numbers from a Home Location Register (HLR), coupled to the first network. The first MNPN further sets in the HLR, a location information entry corresponding to each of the ported-out numbers to an address of the first MNPN. The system further includes a second MNPN coupled to a second network. The second MNPN receives a second query for one or more ported-in numbers from a Gateway Mobile Switching Center (GMSC), coupled to the second network.

### RELATED APPLICATION

This application claims benefit of U.S. provisional patent application Ser. No. 60/737,956, filed on Nov. 17, 2005, entitled, “Scalable Indirect Routing Solution for Mobile Number Portability,” which is incorporated herein by reference in its entirety.

### FIELD OF THE INVENTION

The present invention generally relates to mobile number portability. More specifically, the invention relates to a scaleable mobile number portability system and method for ported numbers.

### BACKGROUND OF THE INVENTION

Almost every country now deploys public mobile communication systems. As a result, more and more subscribers are using mobile phone services. They may wish to change from a network operator in one country to another network operator in the same country without changing their mobile number. Hence, Mobile Number Portability (MNP) use is gaining popularity. MNP allows the subscriber of one network operator to change to another network operator without changing the mobile number. A subscriber using MNP may port-out his number from his current network to a second operator servicing a second network. Then, the subscriber's number is a ported-in number from the perspective of the second network.

There are many known techniques for providing mobile number portability in a country using an Intelligent Network (IN) protocol. IN-based techniques employ either a direct or an indirect routing for call-related signaling. In the direct routing technique, a Gateway Mobile Switching Center (GMSC) queries, using an IN-based message, a Mobile Number Portability Database (MNPDB) for every call to a number of the country before routing the call. Both the GMSC and the MNPDB are present in a network from where the call to the number originates, i.e., an originating network. The MNPDB stores information for all ported numbers. Multiple networks in same country may share the MNPDB. The query is to check whether the number is a ported number or a non-ported number. This direct routing technique is not suitable for international calls from outside the country since it is not practical for a GMSC outside the country to query the MNPDB in the country. Furthermore, this technique is not scalable and even non-ported subscribers bear increased signaling overhead.

In some techniques based on indirect routing, the GMSC in the originating network routes every call for a number to a number range holder network. The number range holder network holds a range of numbers amongst which the number belongs. In one such technique, when a call reaches the number range holder network, a GMSC in the number range holder network queries an MNPDB in the number range holder network using the IN-based message. Only after querying the MNPDB does the GMSC route the call either by querying its Home Location Register (HLR) for routing information for a non-ported number, or to a subscription network for a ported number. The subscription network is a network that services the ported number. However, in this technique, even non-ported subscribers bear signaling overhead.

In another technique using indirect routing, when the call reaches the number range holder network, the GMSC in the number range holder network first queries its own HLR to check for ported status of a subscriber. Upon receiving an unknown subscriber response for the query, the GMSC queries the MNPDB to retrieve routing details for the subscription network, corresponding to the ported number, for routing the call to the subscription network. However, one or more techniques mentioned above cater only to call-related signaling.

Some techniques for providing MNP use a signal relay function. The signal relay function receives all signaling messages: call-related as well as non call-related, for both, ported and non-ported numbers. The signal relay function queries the mobile number portability database to decide on routing of the signaling messages. The signal relay function based techniques are also not scalable and all queries for non-ported numbers suffer from an overhead of routing through the signal relay function.

One or more of the above techniques are expensive to implement because they require an upgrade of some network elements. In addition, the techniques are non-scalable and create signaling overhead even for non-ported subscribers. Therefore, there is a need in the art for a scalable and cost-effective solution to provide mobile number portability without the need for upgrade of network elements.

### SUMMARY

The present invention generally relates to a system, method and computer program product for providing mobile number portability. The system includes a first Mobile Number Portability Node (MNPN) coupled to a first network. The first MNPN receives a first query for one or more ported-out numbers from a Home Location Register (HLR), coupled to the first network. The first MNPN further sets in the HLR, a location information entry corresponding to each of the ported-out numbers, to an address of the first MNPN. The system further includes a second MNPN coupled to a second network. The second MNPN receives a second query for one or more ported-in numbers from a Gateway Mobile Switching Center (GMSC), coupled to the second network.

The invention provides a system for providing mobile number portability. The system includes an MNPN coupled to a second network. The MNPN receives a query for one or more ported-in numbers from a GMSC coupled to the second network.

The invention provides a method for providing mobile number portability. The method includes receiving, at a first MNPN, a first query for one or more ported-out numbers from an HLR. The first MNPN and the HLR are coupled to a first network. The method further includes receiving at a second MNPN, a second query for one or more ported-in numbers from a GMSC. The second MNPN and the GMSC are coupled to a second network.

The invention provides a computer program product for providing mobile number portability. The computer program product includes a computer usable medium including a computer usable program code for receiving at a first MNPN, a first query for one or more ported-out numbers from an HLR. The first MNPN and the HLR are coupled to a first network. The computer program product further includes a computer usable medium including a computer usable program code for receiving at a second MNPN, a second query for one or more ported-in numbers from a GMSC. The second MNPN and the GMSC are coupled to a second network.

### BRIEF DESCRIPTION OF DRAWINGS

FIG. 1 illustrates a system for providing mobile number portability, in accordance with an embodiment of the present invention.

FIG. 2 is a flow chart for providing mobile number portability, in accordance with an embodiment of the present invention.

FIG. 3 is a signal flow diagram representing configuration of a home location register coupled to a first network, for one or more ported-out numbers, in accordance with an embodiment of the present invention.

FIG. 4 is a signal flow diagram representing call-related signaling, in accordance with an embodiment of the present invention.

FIG. 5 is a signal flow diagram representing call-related signaling, in accordance with another embodiment of the present invention.

FIG. 6 is a signal flow diagram representing successful delivery of a short message service (SMS), in accordance with an embodiment of the present invention.

FIG. 7 is a signal flow diagram representing successful delivery of an SMS, in accordance with another embodiment of the present invention.

FIGS. 8A and 8B represent a signal flow diagram representing redelivery of an SMS, in accordance with an embodiment of the present invention.

FIGS. 9A and 9B represent a signal flow diagram representing redelivery of an SMS, in accordance with another embodiment of the present invention.

FIG. 10 represents a signal flow diagram for an Inform Service Center message, in accordance with an embodiment of the present invention.

FIG. 11 represents a signal flow diagram for an Any Time Interrogation message, in accordance with an embodiment of the present invention.

FIG. 12 represents a signal flow diagram for getting an International Mobile Subscriber Identity (IMSI) for one or more ported-out numbers, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

The present invention provides a Mobile Number Portability System (MNPS) for providing mobile number portability when one or more subscribers with corresponding one or more numbers, originally assigned to a first network, keep their mobile phone numbers even when they discontinue their subscription to the first network, and subscribe to a second network in its place. (In this specification we use “porting” to mean that keeping of a phone number when switching network subscriptions.) Hence, these numbers become ported (kept) numbers. The first network is a number range holder network for these ported numbers, and the second network is a subscription network for these ported numbers. The number range holder network is assigned a range of numbers amongst which the subscribers' numbers belong. From a perspective of the number range holder network, the ported numbers are ported out to the second network. Further, from the perspective of the subscription network the ported numbers are ported in from the first network. The MNPS provides a seamless implementation to allow a plurality of services including, but not limited to, call-related services and non call-related services on all these ported numbers and hence serving the associated subscribers. Hence, the MNPS addresses both, the ported-out numbers and the ported-in numbers.

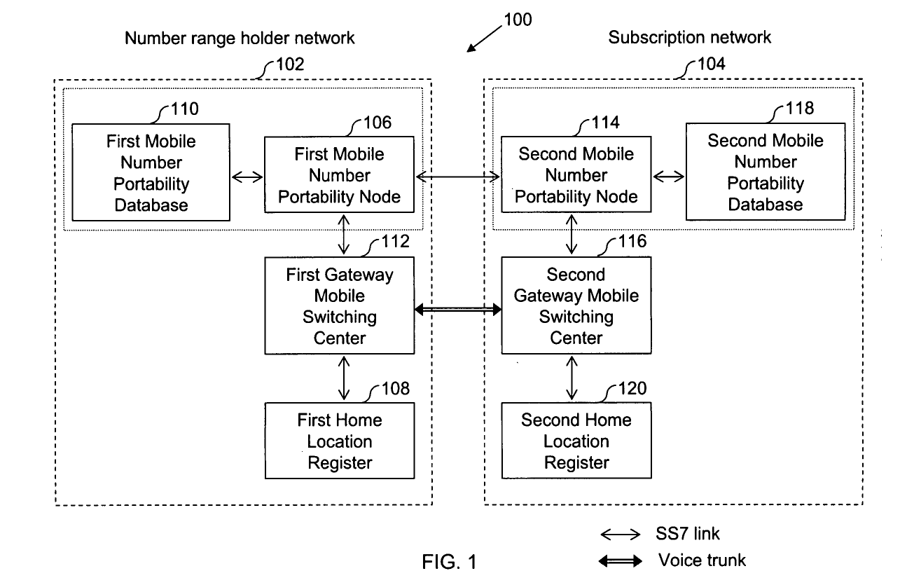

FIG. 1 illustrates a system 100 for providing mobile number portability, in accordance with an embodiment of the present invention. Hereinafter, system 100 may interchangeably mean the MNPS. The subscriber originally associated with a first network 102 may choose to port his number from first network 102 to a second network 104. First network 102 is the number range holder network corresponding to the ported numbers. Further, second network 104 becomes the subscription network corresponding to the ported numbers. In another embodiment of the invention, the subscriber may further choose to port his number from second network 104 to a third network. In such a case, the subscription network (i.e. second network 104) is the third network from the perspective of the subscriber. Further, the number range holder network remains as first network 102 from the perspective of the subscriber. Hereinafter, the number range holder network is interchangeably referred to as first network 102 and the subscription network is interchangeably referred to as second network 104. In one embodiment of the invention, first network 102 and second network 104 are present in the same country. In another embodiment of the invention, first network 102 and second network 104 are present in different countries.

System 100 comprises a first Mobile Number Portability Node (MNPN) 106, a first Home Location Register (HLR) 108, a first Mobile Number Portability Database (MNPDB) 110, and a first Gateway Mobile Switching Center (GMSC) 112. First MNPN 106, first HLR 108, first MNPDB 110, and first GMSC 112 are present in first network 102, and are, hereinafter, referred to as an MNPN-N 106, an HLR-N 108, an MNPDB-N 110, and a GMSC-N 112, respectively. In an embodiment of the present invention, MNPDB-N 110 resides in MNPN-N 106. System 100 further comprises a second MNPN 114, a second GMSC 116, a second MNPDB 118, and a second HLR 120. Second MNPN 114, second GMSC 116, second MNPDB 118, and second HLR 120 are present in second network 104, and are, hereinafter, referred to as an MNPN-S 114, a GMSC-S 116, an MNPDB-S 118, and an HLR-S 120, respectively. In an embodiment of the present invention, MNPDB-S 118 resides in MNPN-S 114.

In an embodiment of the present invention, MNPN-N 106 communicates with HLR-N 108 over a Signaling System #7 (SS7) link, using a protocol such as, but not limited to, a Mobile Application Part (MAP) protocol, or an American National Standard Institute #41 (ANSI-41) protocol. In an embodiment of the present invention, GMSC-N 112 acts as an SS7 router between MNPN-N 106 and HLR-N 108. Further, MNPN-S 114 communicates with HLR-S 120 over an SS7 link, using a protocol such as, but not limited to, the MAP protocol or the ANSI-41 protocol. GMSC-S 116 also acts as an SS7 router between MNPN-S 114 and HLR-S 120. Further, in an embodiment of the present invention, GMSC-N 112 communicates with GMSC-S 116 over a voice trunk using a protocol such as an Integrated Services digital network User Part (ISUP) protocol.

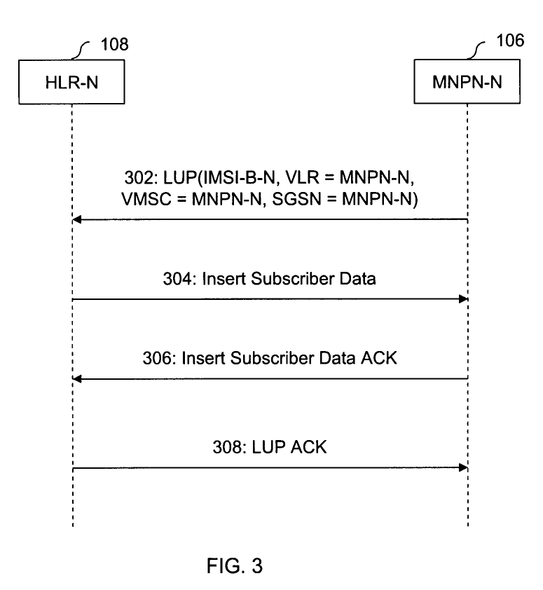

MNPN-N 106 receives a first query for one or more ported-out numbers from HLR-N 108. The first query is a call-related query. Furthermore, MNPN-N 106 sets in HLR-N 108, a location information entry corresponding to each of the ported-out numbers to an address of MNPN-N 106. MNPN-N 106 may set the location information entry by sending a location update message to HLR-N 108. In an embodiment of the present invention, MNPN-N 106 periodically sets the location information entry in HLR-N 108, to prevent HLR-N 108 from timing out the location information entry. Usually, HLR-N 108 removes the entry for all the ported-out numbers. In an embodiment of the present invention, the location information entry includes, but is not limited to, a Visited Location Register (VLR) address, a Visited Mobile Switching Center (VMSC) address, and a Serving General packet radio services Support Node (SGSN) address. In an embodiment of the present invention, the address of MNPN-N 106 is a global title of MNPN-N 106. In another embodiment of the present invention, the address of MNPN-N 106 is a signal point code of MNPN-N 106. Thus, MNPN-N 106 acts as a proxy VLR, a proxy VMSC, and a proxy SGSN for the ported-out numbers in first network 102. A detailed signal flow, which represents configuration of HLR-N 108, is described in conjunction with FIG. 3.

Further, MNPDB-N 110 stores routing information for each of the ported-out numbers. In an embodiment of the present invention, the routing information includes the ported-out number of a subscriber B, a first unique identifier associated with the ported-out number of the subscriber B in first network 102, a second unique identifier associated with the ported-out number of the subscriber B in second network 104, and a prefix of second network 104. Hereinafter, the subscriber B may interchangeably mean the ported-out number B. The routing information may also include either an address of MNPN-S 114, or an address of HLR-S 120. In an embodiment of the present invention, the address of MNPN-S 114 is a global title of MNPN-S 114. In another embodiment of the present invention, the address of MNPN-S 114 is a signal point code of MNPN-S 114. In an embodiment of the present invention, the address of HLR-S 120 is a global title of HLR-S 120. In another embodiment of the present invention, the address of HLR-S 120 is a signal point code of HLR-S 120. In an embodiment of the present invention, the first unique identifier is an International Mobile Subscriber Identity (IMSI) of the ported-out number B in first network 102, and hereinafter, IMSI-B-N refers to the first unique identifier. In an embodiment of the present invention, the second unique identifier is an International Mobile Subscriber Identity (IMSI) of the ported-out number B in second network 104, and hereinafter, IMSI-B-S refers to the second unique identifier.

The ported-out number B, from perspective of first network 102, is the ported-in number B, from the perspective of second network 104. Further, MNPN-S 114 receives a second query for one or more ported-in numbers from GMSC-S 116. GMSC-S 116 sends the second query to MNPN-S 114 using a protocol such as, but not limited to, a MAP protocol and an ANSI-41 protocol. Thus, MNPN-S 114 acts as a proxy HLR for the ported-in numbers in second network 104. MNPDB-S 118 stores routing information for each of the ported-in numbers. In an embodiment of the present invention, the routing information includes the ported-in number B, the first unique identifier associated with the ported-in number B in first network 102, the second unique identifier associated with the ported-in number B in second network 104, and an address of HLR-S 120. In an embodiment of the present invention, the address of HLR-S 120 is a global title of HLR-S 120. In another embodiment of the present invention, the address of HLR-S 120 is a signal point code of HLR-S 120. Further, MNPN-S 114 relays the second query to HLR-S 120.

In an embodiment of the present invention, a service provider may opt to deploy the MNPS for providing mobile number portability only for the ported-out numbers, by implementing MNPN-N 106, HLR-N 108, MNPDB-N 110, and GMSC-N 112, in system 100. In another embodiment of the present invention, another service provider may opt to deploy the MNPS for providing mobile number portability only for the ported-in numbers, by implementing MNPN-S 114, GMSC-S 116, MNPDB-S 118, and HLR-S 120, in system 100.

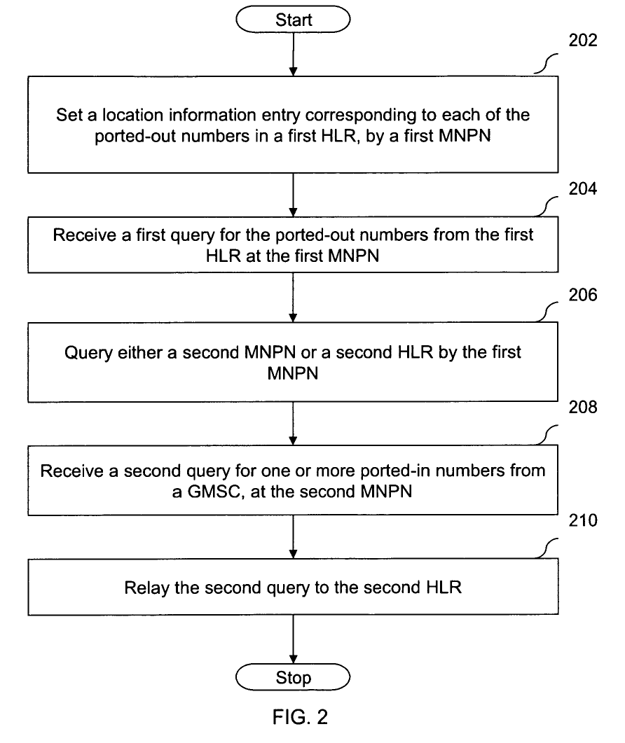

FIG. 2 is a flow chart for providing mobile number portability, in accordance with an embodiment of the present invention. At step 202, a first MNPN sets in a first HLR, a location information entry corresponding to each of the ported-out numbers, to an address of the first MNPN. The first MNPN and the HLR reside in a first network. In an embodiment, first MNPN 106 sets the location information entry in first HLR 108. At step 204, first MNPN 106 receives a first query for the ported-out numbers from first HLR 108. In an embodiment of the present invention, first MNPN 106 receives the first query from a Short Message Service Center (SMSC) coupled to an originating network. The first query includes, but is not limited to, Provide Roaming Number (PRN) query, Provide Subscriber Information (PSI) query, and a Forward Short Message Service (FwdSMS) query.

Thereafter, at step 206, the first MNPN queries either a second MNPN or a second HLR, for routing information of the ported-out numbers. The second MNPN and the second HLR reside in a second network. In an embodiment of the present invention, first MNPN 106 queries second MNPN 114 or second HLR 120. In an exemplary case, first MNPN 106 receives a PRN message as the first query and thereafter sends an SRI message as the query to second MNPN at step 206. It would be apparent to a person skilled in the art that the first MNPN, the first HLR, the second MNPN, and the second HLR exchange various other signals to complete mobile number portability call flow for the ported-out numbers.

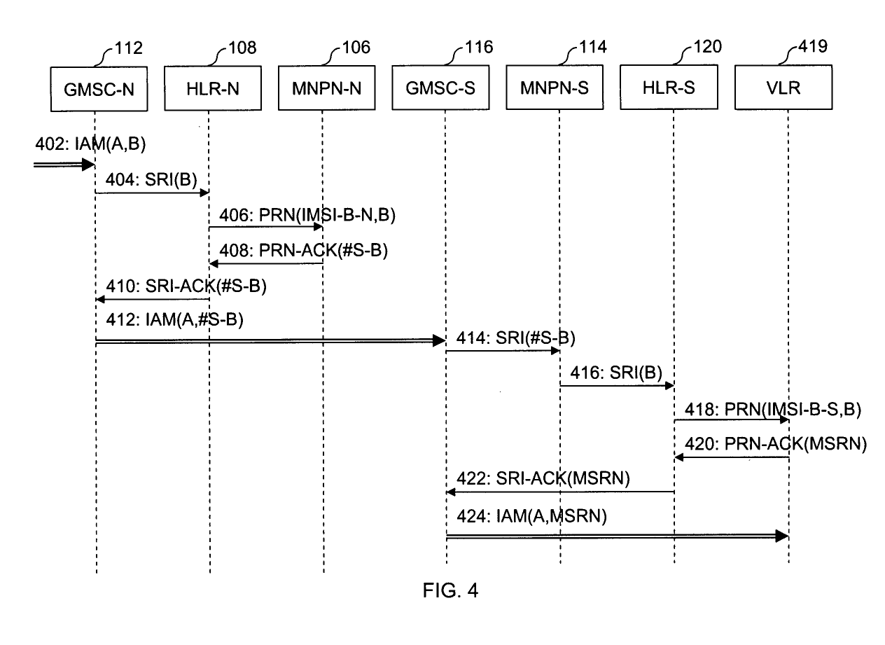

In accordance with another embodiment of the invention, at step 208, the second MNPN receives a second query for the ported-in numbers from a second GMSC. In accordance with an embodiment of the invention, second GMSC 116 resides in second network 104. The second query includes, but is not limited to, a Send Routing Information (SRI) query, a Send Routing Information for Short Message (SRI-SM) query, and an Any Time Interrogation (ATI) query. At step 210, second MNPN 114 relays the second query to second HLR 120 to complete a call flow for the second query. A detailed description of various embodiments for completing the call flow for the second query are described in conjunction with FIG. 4 to FIG. 11.

FIG. 3 is a signal flow diagram representing configuration of HLR-N 108 for one or more ported-out numbers, in accordance with an embodiment of the present invention. At step 302, MNPN-N 106 sets addresses of a VLR, a VMSC, and an SGSN, corresponding to each of the ported-out numbers, to an address of MNPN-N 106. MNPN-N 106 may use a location update command or an LUP message for changing the addresses. The LUP message for IMSI-B-N (i.e. the IMSI of number B in first network 102) replaces the VLR address with the address of MNPN-N 106, and VMSC address with the address of MNPN-N 106. The LUP message may also replace the SGSN address with the address of MNPN-N 106. Further, at step 304, HLR-N 108 sends a response for the location update request to the MNPN-N 106, using a message, such as an Insert Subscriber Data (ISD). In an embodiment of the present invention, HLR-N 108 sends a plurality of responses (i.e. the ISD) for the location update request to MNPN-N 106. At step 306, MNPN-N 106 sends an acknowledgement to HLR-N 108, using a message such as an Insert Subscriber Data Acknowledgement (ISD-ACK). Finally, at step 308, HLR-N 108 sends to MNPN-N 106, an acknowledgement to the location update request (i.e. the LUP message at step 302), using a message such as a Location Update Acknowledgement (LUP-ACK). Hence, the configuration of HLR-N 108 completes.

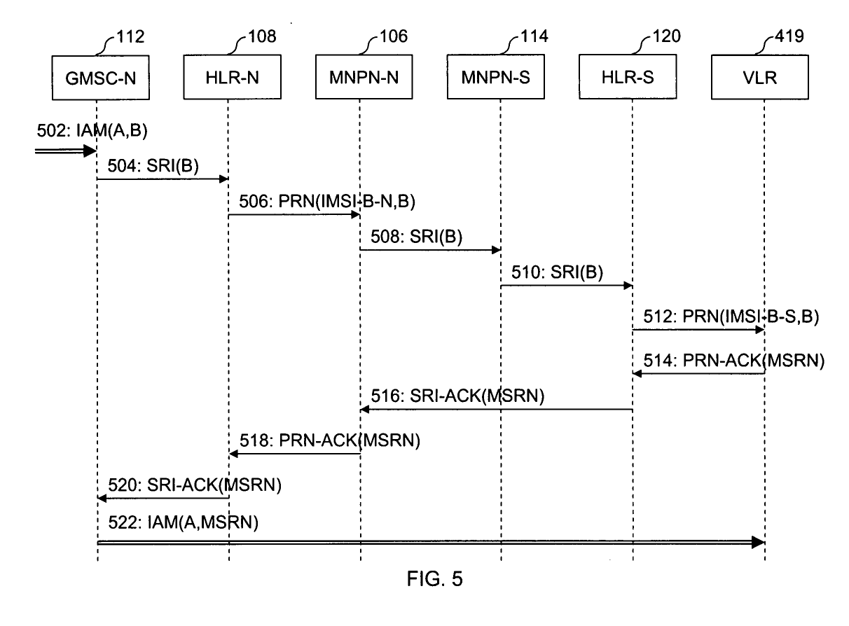

FIG. 4 and FIG. 5 illustrate various embodiments corresponding to call-related signaling using indirect routing. FIG. 4 is a signal flow diagram representing call-related signaling, in accordance with an embodiment of the present invention. At step 402, GMSC-N 112 receives a call-related query, from a number A to the ported-out number B, in the form of a message such as an Initial Address Message [IAM(A,B)]. At step 404, GMSC-N 112 issues a routing information query to HLR-N 108, using a Send Routing Information query [SRI(B)]. Thereafter, at step 406, HLR-N 108 issues a roaming number query for the ported-out number B to MNPN-N 106, using a Provide Roaming Number query [PRN(IMSI-B-N,B)]. MNPN-N 106 accesses routing information for the ported-out number B from MNPDB-N 110. MNPN-N 110 prefixes the ported-out number B with the prefix of the second network (#S), to generate a prefixed ported-out number (#S-B). At step 408, MNPN-N 106 sends the prefixed ported-out number (#S-B) to HLR-N 108 as an acknowledgement to the roaming number query, using a Provide Roaming Number query Acknowledgement [PRN-ACK(#S-B)]. Thereafter, at step 410, HLR-N 108 sends the prefixed ported-out number #S-B to GMSC-N 112, as an acknowledgement to the routing information query, using a Send Routing Information Acknowledgement [SRI-ACK(#S-B)].

Further, at step 412, GMSC-N 112 issues a call connection query for the prefixed ported-out number #S-B to GMSC-S 116, using an Initial Address Message [IAM(A,#S-B)]. GMSC-S 116 detects the call connection query for the ported-in number B using the second network's prefix #S. At step 414, GMSC-S 116 issues routing information query SRI(#S-B), for the prefixed ported-in number B to MNPN-S 114. MNPN-S 114 accesses the routing information for the ported-in number B from MNPDB-S 118. MNPN-S 114 removes the second network's prefix #S. Thereafter, at step 416, MNPN-S 114 sends a routing information query SRI(B), for the ported-in number B to HLR-S 120. Thereafter, at step 418, HLR-S 120 issues a roaming number query PRN(IMSI-B-S,B) to a Visited Location Register (VLR) 419. VLR 419 represents a current location of a subscriber B (i.e. the ported-in number) in second network 104. Since the ported-in number B is roaming in VLR 419, at step 420, VLR 419 returns the roaming number (i.e. an MSRN), corresponding to the ported-in number B, to HLR-S 120, as a Provide Roaming Number query Acknowledgement [PRN-ACK(MSRN)]. Further, at step 422, HLR-S 120 relays the roaming number (MSRN) to GMSC-S 116, as a routing information query acknowledgement, SRI-ACK(MSRN), in response to earlier received routing information query at step 414. Finally, at step 424, GMSC-S 116 sends a call connection query for the roaming number to VLR 419 using an Initial Address Message, IAM(A,MSRN).

In accordance with various embodiments of the invention, it would be apparent to a person skilled in the art that, all messages exchanged between various system components are purely for explanation purposes, and hence other types of messages conforming to the protocol under consideration may also be used. In an embodiment of the present invention, a service provider may deploy the MNPS for providing mobile number portability only for the ported-in numbers. In such a case, only steps 412 to 424 represent call-related signaling for the ported-in numbers.

FIG. 5 is a signal flow diagram corresponding to call-related signaling, in accordance with another embodiment of the present invention. The embodiment enables first network 102 to directly interact with HLR-S 120 to complete the call related signaling without configuring GMSC-S 116, as explained in conjunction with FIG. 4. At step 502, GMSC-N 112 receives a call-related query, from a number A to the ported-out number B, in the form of a message such as an Initial Address Message [IAM(A,B)]. Thereafter, at step 504, GMSC-N 112 issues a routing information query for the ported-out number B to HLR-N 104, using a Send Routing Information query [SRI(B)]. At step 506, HLR-N 108 issues a Provide Roaming Number query, PRN(IMSI-B-N,B) for the ported-out number B to MNPN-N 106. Thereafter, at step 508, MNPN-N 106 issues a routing information query for the ported-out number B to MNPN-S 114, using a message such as a Send Routing Information query [SRI(B)]. Further, at step 510, MNPN-S 114 relays the routing information query, SRI(B), to HLR-S 120. At step 512, HLR-S 120 issues a roaming number query, PRN(IMSI-B-S,B), to a Visited Location Register (VLR) 419. VLR 419 represents a current location of a subscriber B (i.e. the ported-in numbers B) in second network 104.

Since the ported-in number B is roaming in VLR 419, at step 514, VLR 419 returns the roaming number (i.e. an MSRN), corresponding to the ported-in number B, to HLR-S 120, as a Provide Roaming Number query Acknowledgement [PRN-ACK(MSRN)]. Further, at step 516, HLR-S 120 sends the roaming number (MSRN) to MNPN-N 106, using a routing information query acknowledgement, SRI-ACK(MSRN). At step 518, MNPN-N 106 sends Provide Roaming Number query Acknowledgement, PRN-ACK(MSRN), to HLR-N 108, as an acknowledgement to the provide roaming number query (at step 506). At step 520, HLR-N 108 sends the roaming number (MSRN) to GMSC-N 112, as a Send Routing Information Acknowledgement, SRI-ACK(MSRN), in response to earlier received routing information query at step 504. Finally, at step 522, GMSC-N 112 directly routes the call to the ported-out number B, by sending an Initial Address Message, IAM(A,MSRN), to VLR 419.

In an embodiment of the present invention, when a service provider deploys the MNPS for providing mobile number portability only for the ported-out numbers, MNPN-N 106, at step 508, issues the routing information query to HLR-S 120 instead of MNPN-S 114.

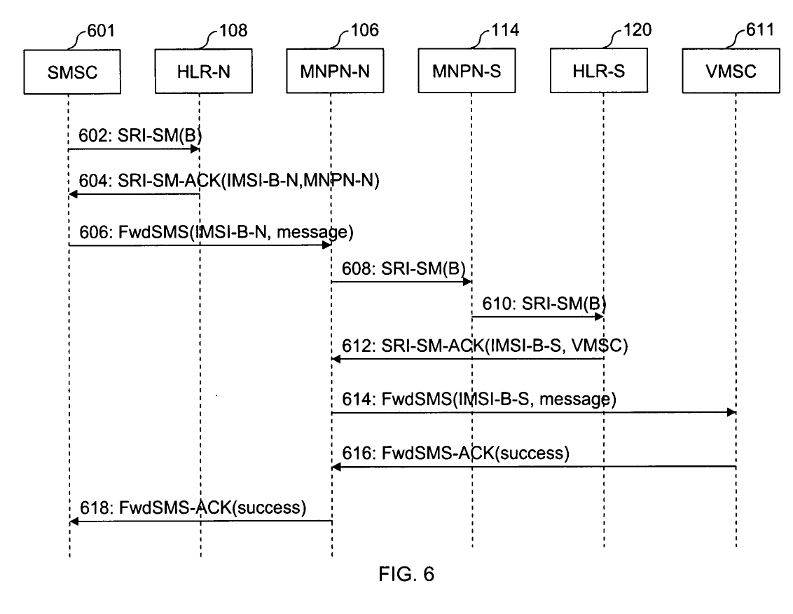

The MNPS facilitates non call-related services for both: one or more ported-out numbers as well as one or more ported-in numbers. The non call-related services include SMS related signaling. FIGS. 6 to 10 illustrate various embodiments corresponding to the SMS related signaling using indirect routing. FIG. 6 is a signal flow diagram representing successful delivery of a short message service, in accordance with an embodiment of the present invention. A Short Message Service Center (SMSC) 601, coupled to an originating network, stores an SMS intended for the ported-out number B. At step 602, SMSC 601 sends a routing information query SRI-SM(B), for the ported-out number B to HLR-N 108. HLR-N 108 retrieves location information for the ported-out number B. The location information includes an IMSI-B-N and an address of MNPN-N 106. Thereafter, at step 604, HLR-N 108 returns the location information to SMSC 601, by sending SRI-SM-ACK(IMSI-B-N, MNPN-N), as an acknowledgement to the routing information query. Thereafter, at step 606, SMSC 601 sends the SMS intended for the ported-out number B to the MNPN-N 106, using a Forward Short Message Service [FwdSMS(IMSI-B-N, message)].

At step 608, MNPN-N 106 sends a routing information query SRI-SM(B), for the ported-out number B to MNPN-S 114. Thereafter, at step 610, MNPN-S 114 relays the routing information query SRI-SM(B), to HLR-S 120. Thereafter, HLR-S 120 retrieves location information for the ported-in number B. The location information may include an IMSI-B-S and an address of a Visited Mobile Switching Center (VMSC) 611 representing the current location of a subscriber B (i.e. the ported-in number). In an embodiment of the present invention, the address of VMSC 611 is a global title of VMSC 611. In another embodiment of the present invention, the address of VMSC 611 is a signal point code of VMSC 611. Thereafter, at step 612, HLR-S 120 returns the location information for the ported-in number B, to MNPN-N 106, as a Send Routing Information for Short Message Acknowledgement, SRI-SM-ACK(IMSI-B-S, VMSC), in response to the routing information query. Thereafter, at step 614, MNPN-N 106 sends an FwdSMS(IMSI-B-S, message) message to VMSC 611. At step 616, VMSC 611 informs MNPN-N 106 of a successful SMS delivery, using Forward Short Message Service Acknowledgement, FwdSMS-ACK(success). Further, at step 618, MNPN-N 106 informs SMSC 601 of the successful SMS delivery using a message such as a Forward Short Message Service Acknowledgement, [FwdSMS-ACK(success)].

In an embodiment of the present invention, when a service provider deploys the MNPS for providing mobile number portability only for the ported-out numbers, MNPN-N 106, at step 608, issues the routing information query to HLR-S 120 instead of MNPN-S 114. In an embodiment of the present invention, when a service provider deploys the MNPS for providing mobile number portability only for the ported-in numbers B, steps 608 to 616 represent the successful delivery of an SMS intended for the ported-in number B.

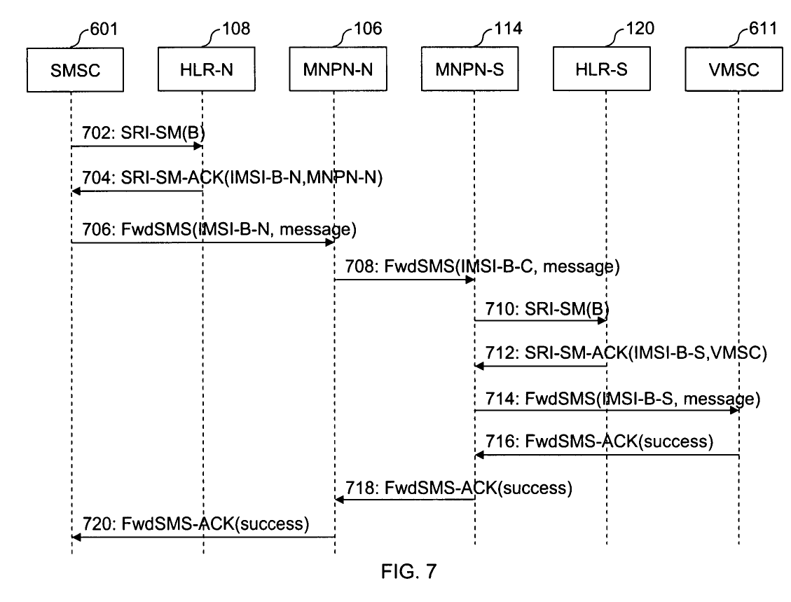

FIG. 7 is a signal flow diagram representing successful delivery of a short message service, in accordance with another embodiment of the present invention. MNPN-N 106 delivers an SMS intended for the ported-out number B to MNPN-S 114 unlike as described in FIG. 6 where MNPN-N 106 only requests routing information for the subscriber B (i.e. the ported-in number) in second network 104 from MNPN-S 114. SMSC 601 stores an SMS intended for the ported-out number B. At step 702, SMSC 601 sends a routing information query SRI-SM(B), for the ported-out number B, to HLR-N 108. HLR-N 108 retrieves location information for the ported-out number B. The location information may include an IMSI-B-N and an address of MNPN-N 106. Thereafter, at step 704, HLR-N 108 returns the location information to SMSC 601, by sending SRI-SM-ACK(IMSI-B-N, MNPN-N), as an acknowledgement to the routing information query. Thereafter, at step 706, SMSC 601 sends the SMS intended for the ported-out number B to MNPN-N 106, using a Forward Short Message Service [FwdSMS(IMSI-B-N, message)].

Further, at step 708, MNPN-N 106 sends the SMS intended for the ported-out number B to MNPN-S 114, using a Forward Short Message Service [FwdSMS(IMSI-B-C, message)], where IMSI-B-C is either IMSI-B-N or IMSI-B-S. MNPN-S 114 finds the ported-in number B from the IMSI-B-C and MNPDB-S 118. Thereafter, at step 710, MNPN-S 114 sends a routing information query for short message, SRI-SM(B), for the ported-in number B to HLR-S 120. HLR-S 120 retrieves location information for the ported-in number B in second network 104. The location information includes an IMSI-B-S and an address of a Visited Mobile Switching Center (VMSC) 611 representing a current location of a subscriber B, i.e., the ported-in number in second network 104. At step 712, HLR-S 120 returns the location information for the ported-in number B to MNPN-S 114, by sending SRI-SM-ACK(IMSI-B-S, VMSC), as an acknowledgement to the routing information query for short message. Thereafter, at step 714, MNPN-S 114 sends the SMS intended for the ported-in number B to VMSC 611 using a Forward Short Message Service [FwdSMS(IMSI-B-S, message)]. Further, at step 716, VMSC 611 informs MNPN-S 114 of a successful SMS delivery, using a message such as a Forward Short Message Service Acknowledgement [FwdSMS-ACK(success)]. At step 718, MNPN-S 114 informs MNPN-N 106 about the successful SMS delivery, using FwdSMS-ACK(success) message. Finally, at step 720, MNPN-N 106 informs SMSC 601 of the successful SMS delivery, by sending FwdSMS-ACK(success) message.

In an embodiment of the present invention, MNPN-N 106 exchanges one or more messages with first network 102, and second network 104, for redelivering the SMS intended for the ported-out numbers upon failure of the SMS delivery. These messages include, but are not limited to, a Forward Short Message Service failure message FwdSMS-ACK(failure), a Report Short Message Service Delivery message ReportSMSDelivery, a Report Short Message Service Delivery Acknowledgement ReportSMSDelivery-ACK, an Alert Service Center message AlertSC, an Alert Service Center Acknowledgement AlertSC-ACK, an Inform Service Center message Inform-SC, a Ready For Short Message Service delivery message ReadyForSMS, and a Ready for Short Message Service delivery Acknowledgement ReadyForSMS-ACK.

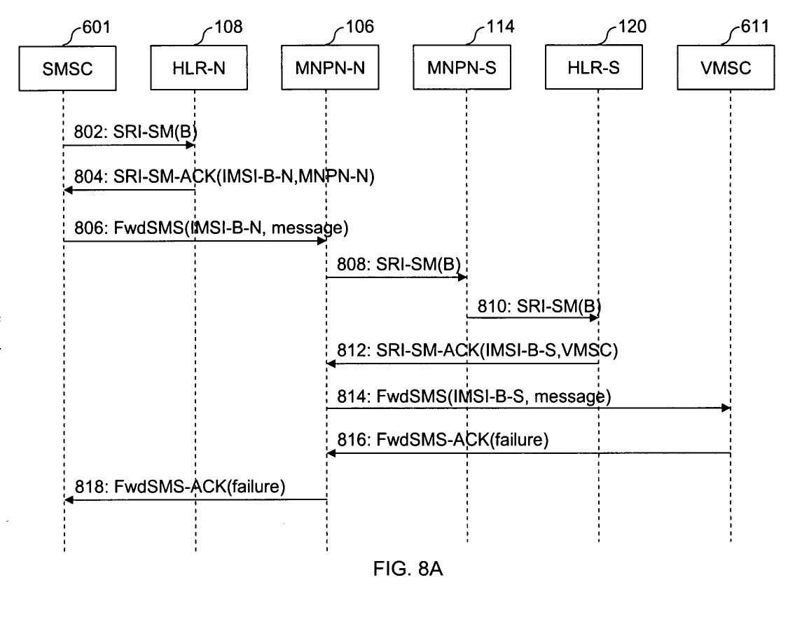

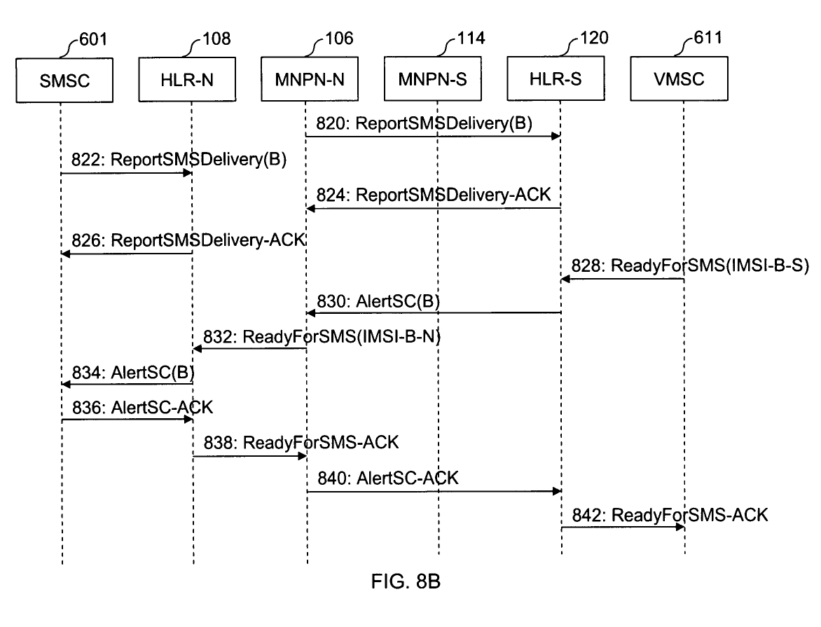

FIGS. 8A and 8B represent a signal flow diagram representing redelivery of an SMS, in accordance with an embodiment of the present invention. SMSC 601 stores an SMS intended for the ported-out number B. At step 802, SMSC 601 sends a routing information query for short message SRI-SM(B), for the ported-out number B, to HLR-N 108. HLR-N 108 retrieves location information for the ported-out number B. The location information includes an IMSI-B-N and an address of MNPN-N 106. Thereafter, at step 804, HLR-N 108 returns the location information to SMSC 601, by sending SRI-SM-ACK(IMSI-B-N, MNPN-N), as an acknowledgement to the routing information query. At step 806, SMSC 601 sends the SMS intended for the ported-out number B to MNPN-N 106, using an FwdSMS(IMSI-B-N, message) message.

Thereafter, at step 808, MNPN-N 106 sends a routing information query for the ported-out number B to MNPN-S 114, using a message such as a Send Routing Information for Short Message [SRI-SM(B)]. Thereafter, at step 810, MNPN-S 114 relays the routing information query SRI-SM(B), for the ported-in number B, to HLR-S 120. HLR-S 120 retrieves location information for the ported-in number B in second network 104. The location information may include an IMSI-B-S and an address of a Visited Mobile Switching Center (VMSC) 611. VMSC 611 represents a current location of a subscriber B, i.e., the ported-in number, in second network 104. Thereafter, at step 812, HLR-S 120 returns the location information to MNPN-N 106, using a SRI-SM-ACK(IMSI-B-S, VMSC) message. Thereafter, at step 814, MNPN-N 106 sends the SMS intended for the ported-in number B to VMSC 611, using an FwdSMS(IMSI-B-S, message) message. At step 816, VMSC 611 informs MNPN-N 106 of a SMS delivery failure using a Forward Short Message Service Acknowledgement [FwdSMS-ACK(failure)]. Thereafter, at step 818, MNPN-N 106 informs SMSC 601 of the SMS delivery failure using an FwdSMS-ACK(failure) message.

Thereafter, at step 820, MNPN-N 106 requests HLR-S 120 to send a message delivery status to MNPN-N 106 using, a Report Short Message Service Delivery query, such as ReportSMSDelivery(B). At step 822, SMSC 601 requests HLR-N 108 to send a message delivery status to SMSC 601, using a ReportSMSDelivery(B) message. Thereafter, at step 824, HLR-S 120 sends an acknowledgement to the message delivery status request to MNPN-N 106, using a Report Short Message Service Delivery Acknowledgement message, such as ReportSMSDelivery-ACK. Thereafter, at step 826, HLR-N 108 sends an acknowledgement for the message delivery status request to SMSC 601, using a Report Short Message Service Delivery Acknowledgement message, ReportSMSDelivery-ACK.

At step 828, VMSC 611 informs its availability to receive the SMS, to HLR-S 120, by sending a Ready For SMS message, such as ReadyForSMS(IMSI-B-S). VMSC 611 is available because the ported-in number B is available to receive the SMS. Thereafter, at step 830, HLR-S 120 informs MNPN-N 106 of the availability of the ported-in number B to receive the SMS, using an Alert Service Center message [AlertSC(B)]. Thereafter, at step 832, MNPN-N 106 informs HLR-N 108 of the availability of the ported-out number B to receive the SMS, by sending a ReadyForSMS(IMSI-B-N) message. At step 834, HLR-N 108 informs SMSC 601 of the availability of the ported-out number B to receive the SMS, using a message, such as an Alert Service Center [AlertSC(B)]. Thereafter, at step 836, SMSC 601 sends an acknowledgement to HLR-N 108, using an Alert Service Center Acknowledgement [AlertSC-ACK]. Thereafter, at step 838, HLR-N 108 sends a ReadyForSMS-ACK message to MNPN-N 106, as an acknowledgement to the ReadyForSMS message received at step 832. Further, at step 840, MNPN-N 106 sends an Alert Service Center Acknowledgement message, AlertSC-ACK, to HLR-S 120. Finally, at step 842, HLR-S 120 acknowledges to VMSC 611, using a message, such as ReadyForSMS-ACK. Thereafter, SMSC 601 starts a redelivery of the SMS, intended for the ported-out number B, from step 802.

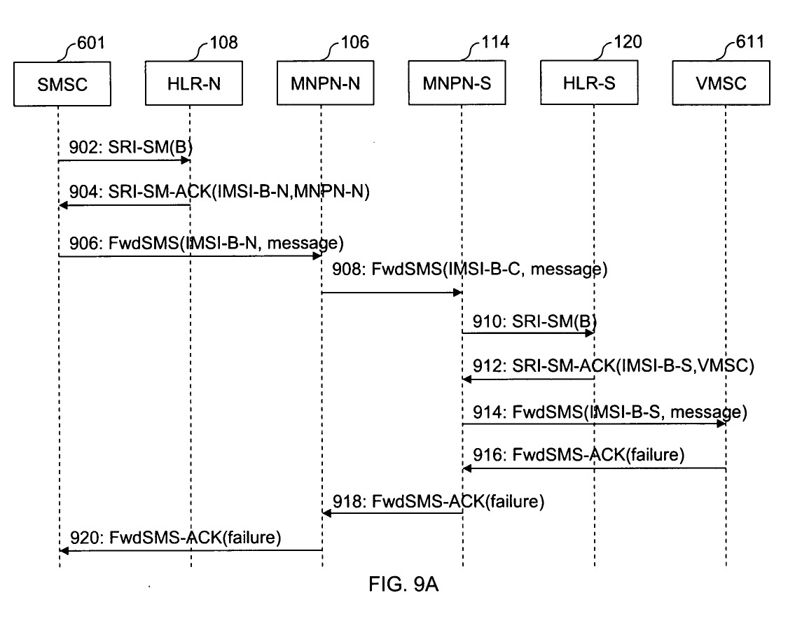

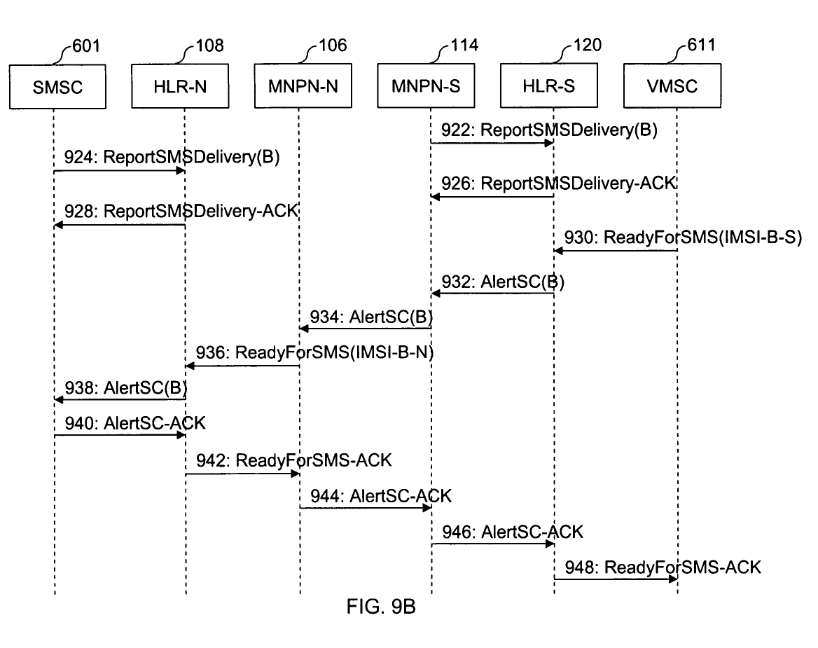

In another embodiment of the present invention, MNPN-N 106 and MNPN-S 114 exchange the one or more messages with first network 102, and second network 104 for redelivering the SMS intended for the ported-out numbers upon failure of the SMS delivery. FIGS. 9A and 9B represent a signal flow diagram representing redelivery of an SMS, in accordance with another embodiment of the present invention. SMSC 601 stores an SMS intended for the ported-out number B. At step 902, SMSC 601 sends a routing information query for short message SRI-SM(B), for the ported-out number B, to HLR-N 108. HLR-N 108 retrieves location information for the ported-out number B. The location information includes an IMSI-B-N and an address of MNPN-N 106. Thereafter, at step 904, HLR-N 108 returns the location information to SMSC 601, by sending SRI-SM-ACK(IMSI-B-N, MNPN-N), as an acknowledgement to the routing information query. At step 906, SMSC 601 sends the SMS intended for the ported-out number B to MNPN-N 106, using an FwdSMS(IMSI-B-N, message) message.

Further, at step 908, MNPN-N 106 sends the SMS intended for the ported-out number B to MNPN-S 114, using a Forward Short Message Service [FwdSMS(IMSI-B-C, message)], where IMSI-B-C is either IMSI-B-N or IMSI-B-S. MNPN-S 114 finds the ported-in number B from the IMSI-B-C and MNPDB-S 118. Thereafter, at step 910, MNPN-S 114 sends a routing information query SRI-SM(B), for the ported-in number B, to HLR-S 120. HLR-S 120 retrieves location information for the ported-in number B in second network 104. The location information may include an IMSI-B-S and an address of a Visited Mobile Switching Center (VMSC) 611. VMSC 611 represents a current location of a subscriber B, i.e. the ported-in number, in second network 104. Thereafter, at step 912, HLR-S 120 returns the location information to MNPN-S 114, using a SRI-SM-ACK(IMSI-B-S, VMSC) message. Thereafter, at step 914, MNPN-S 114 sends the SMS intended for the ported-in number B to VMSC 611, using an FwdSMS(IMSI-B-S, message) message. At step 916, VMSC 611 informs MNPN-S 114 of a SMS delivery failure, using a Forward Short Message Service Acknowledgement [FwdSMS-ACK(failure)]. At step 918, MNPN-S 114 informs MNPN-N 106 of the SMS delivery failure, using an FwdSMS-ACK(failure) message. Thereafter, at step 920, MNPN-N 106 informs SMSC 601 of the SMS delivery failure, using an FwdSMS-ACK(failure) message.

At step 922, MNPN-S 114 requests HLR-S 120 to send a message delivery status to MNPN-S 114, using a Report Short Message Service Delivery query, such as ReportSMSDelivery(B). At step 924, SMSC 601 requests HLR-N 108 to send a message delivery status to SMSC 601, using a ReportSMSDelivery(B) message. Further, at step 926, HLR-S 120 sends an acknowledgement to the message delivery status request to MNPN-S 114, using a Report Short Message Service Delivery Acknowledgement message, such as ReportSMSDelivery-ACK. Thereafter, at step 928, HLR-N 108 sends an acknowledgement for the message delivery status request to SMSC 601, using a Report Short Message Service Delivery Acknowledgement message, (ReportSMSDelivery-ACK).

At step 930, VMSC 611 informs of its availability to receive the SMS, to HLR-S 120, using a Ready For SMS message, such as ReadyForSMS(IMSI-B-S). VMSC 611 informs of its availability because the ported-in number B is available with it to receive the SMS. Thereafter, at step 932, HLR-S 120 informs MNPN-S 114 of the availability of the ported-in number B to receive the SMS, using an Alert Service Center, AlertSC(B) message. Thereafter, at step 934, MNPN-S 114 informs MNPN-N 106 of the availability of the ported-in number B to receive the SMS, using an Alert Service Center, AlertSC(B) message. Thereafter, at step 936, MNPN-N 106 informs HLR-N 108 of the availability of the ported-out number B to receive the SMS, by sending a ReadyForSMS(IMSI-B-N) message. At step 938, HLR-N 108 informs SMSC 601 of the availability of the ported-out number B to receive the SMS, using a message, such as an Alert Service Center [AlertSC(B)]. Thereafter, at step 940, SMSC 601 sends an acknowledgement to HLR-N 108, using an Alert Service Center Acknowledgement [AlertSC-ACK]. Thereafter, at step 942, HLR-N 108 sends a ReadyForSMS-ACK message to MNPN-N 106, as an acknowledgement to the ReadyForSMS message received at step 936. Thereafter, at step 944, MNPN-N 106 sends an Alert Service Center Acknowledgement, AlertSC-ACK, to MNPN-S 114. Thereafter, at step 946, MNPN-S 114 sends an Alert Service Center Acknowledgement message, AlertSC-ACK, to HLR-S 120. Finally, at step 948, HLR-S 120 acknowledges to VMSC 611, using a message, such as ReadyForSMS-ACK. Thereafter, SMSC 601 starts a redelivery of the SMS intended for the ported-out number B from step 902.

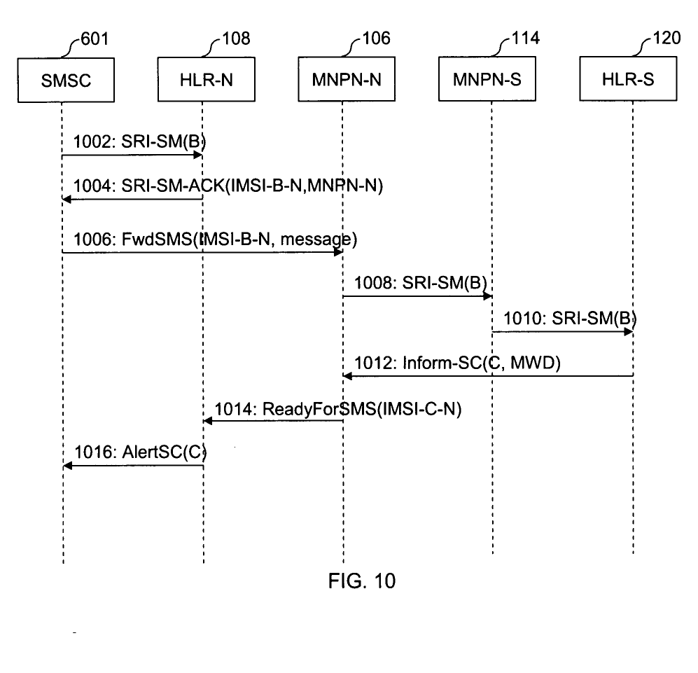

When an SMSC sends an SMS intended for a number to an HLR and another SMS intended for another number sent by the SMSC is waiting in a message queue, the HLR informs the SMSC of the message queue status, using a message such as an Inform Service Center (Inform-SC). FIG. 10 represents a signal flow diagram for an Inform Service Center message, in accordance with an embodiment of the present invention. SMSC 601 stores an SMS intended for ported-out number B. At step 1002, SMSC 601 sends a routing information query for short message SRI-SM(B), for the ported-out number B to HLR-N 108. HLR-N 108 retrieves location information for the ported-out number B. The location information may include an IMSI-B-N, and an address of MNPN-N 106. Thereafter, at step 1004, HLR-N 108 returns the location information to SMSC 601, by sending SRI-SM-ACK(IMSI-B-N, MNPN-N), as an acknowledgement to the routing information query. Thereafter, at step 1006, SMSC 601 sends the SMS intended for the ported-out number B to MNPN-N 106, using a Forward Short Message Service [FwdSMS(IMSI-B-N, message)].

Thereafter, at step 1008, MNPN-N 106 sends a routing information query, for the ported-out number B to MNPN-S 114, using Send Routing Information for Short Message [SRI-SM(B)]. At step 1010, MNPN-S 114 relays the SRI-SM(B) message to HLR-S 120. HLR-S 120, thereafter, identifies that another SMS, intended for another ported-in number C, is waiting in a message queue. Hence, at step 1012, HLR-S 120 informs MNPN-N 106 about the SMS intended for C, by using an Inform Service Center message [Inform-SC(C,MWD)]. Thereafter, at step 1014, MNPN-N 106 informs HLR-N 108 that the another SMS for C is waiting in the message queue, by sending ReadyForSMS(IMSI-C-N) message to HLR-N 108. Finally, at step 1016, HLR-N 108 informs SMSC 601 about the SMS for C, by sending an Alert Service Center message [AlertSC(C)].

In an embodiment of the present invention, when a service provider deploys the MNPS for providing mobile number portability only for the ported-out numbers, MNPN-N 106, at step 1008, issues the routing information query to HLR-S 120 instead of MNPN-S 114.

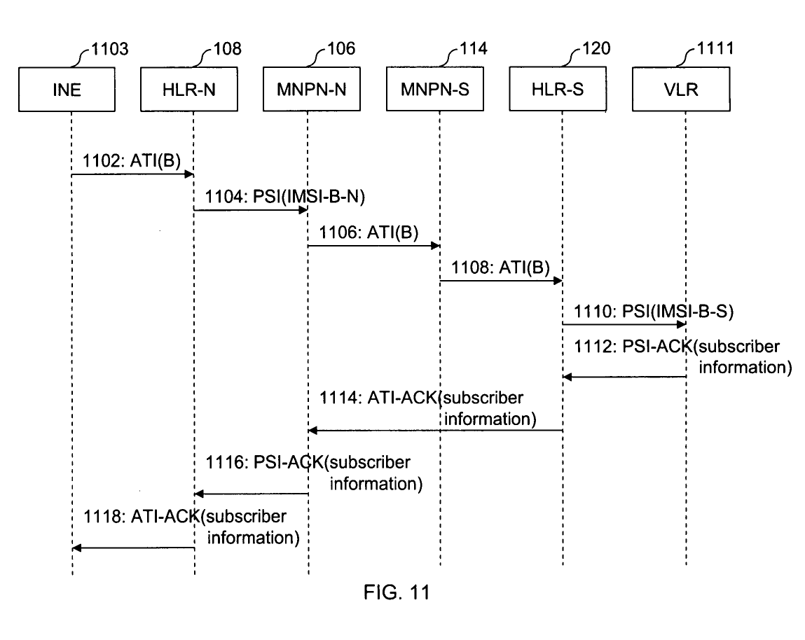

The non call-related services further include a subscriber information request, such as an Any Time Interrogation message. FIG. 11 represents a signal flow diagram for an Any Time Interrogation message, in accordance with an embodiment of the present invention. At step 1102, an Interrogating Network Entity (INE) 1103, coupled to an originating network, sends a subscriber information request for ported-out number B to HLR-N 108, using an Any Time Interrogation query [ATI(B)]. In an embodiment of the present invention, INE 1103 is a Global System for Mobile communications Service Control Function (gsmSCF), coupled to the originating network. Thereafter, at step 1104, HLR-N 108 queries MNPN-N 106 for the subscriber information for the ported-out number B, using a Provide Subscriber Information query [PSI(IMSI-B-N)]. Thereafter, at step 1106, MNPN-N 106 sends the subscriber information request for the ported-out number B to MNPN-S 114, using a message, such as an Any Time Interrogation query, ATI(B). At step 1108, MNPN-S 114 relays the ATI(B) message to HLR-S 120. Thereafter, at step 1110, HLR-S 120 queries a Visited Location Register (VLR) 1111 for the subscriber information for the ported-in number B using a Provide Subscriber Information query [PSI(IMSI-B-S)]. VLR 1111 represents a current location of the subscriber B i.e. the ported-in number, in second network 104.

Thereafter, at step 1112, VLR 1111 sends the subscriber information for the ported-in number B, to HLR-S 120, as an acknowledgement message PSI-ACK(subscriber information). Thereafter, at step 1114, HLR-S 120 sends the subscriber information for the ported-in number B to MNPN-N 106, using a message, such as an Any Time Interrogation Acknowledgement, ATI-ACK(subscriber information). Further, at step 1116, MNPN-N 106 sends the subscriber information for the ported-out number B to HLR-N 108, using a message, such as a Provide Subscriber Information Acknowledgement [PSI-ACK(subscriber information)]. Finally, at step 1118, HLR-N 106 sends the subscriber information for the ported-out number B to INE 1103, using a message, such as ATI-ACK(subscriber information).

In an embodiment of the present invention, when a service provider deploys the MNPS for providing mobile number portability only for the ported-out numbers, MNPN-N 106, at step 1106, issues the subscriber information request to HLR-S 120 instead of MNPN-S 114. In another embodiment of the present invention, when a service provider deploys the MNPS for providing mobile number portability only for the ported-in numbers, steps 1106 to 1114 represent the signal flow for the ATI query for the ported-in number B.

The non call-related services further include getting an International Mobile Subscriber Identity (IMSI), associated with the ported-out number B, in second network 104. When an Interrogating Network Entity (INE), coupled to an originating network, wants an IMSI associated with the ported-out number B, the INE sends a query requesting the IMSI to an HLR. In an embodiment of the present invention, the INE sends the query to MNPN-N 106 instead of HLR-N 108.

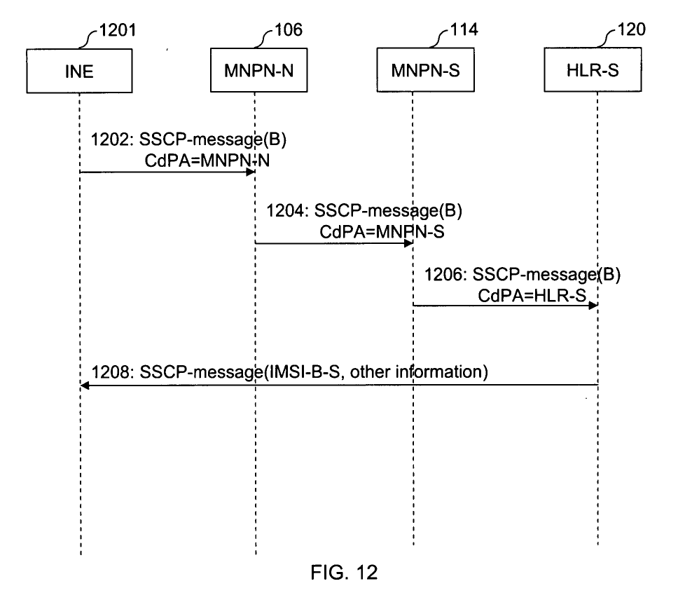

FIG. 12 represents a signal flow diagram for getting an International Mobile Subscriber Identity (IMSI) for a ported-out number, in accordance with an embodiment of the present invention. An INE 1201, coupled to an originating network, wants an IMSI associated with the ported-out number B in second network 104. At step 1202, INE 1201 sends an SCCP message for the ported-out number B to MNPN-N 106. INE 1201 sets a Called Party Address (CdPA) to an address of MNPN-N 106. In an embodiment of the present invention, the address of MNPN-N 106 is a global title of MNPN-N 106. In another embodiment of the present invention, the address of MNPN-N 106 is a signal point code of MNPN-N 106. Thereafter, at step 1204, MNPN-N 106 sends the SCCP message for the ported-out number B to MNPN-S 114. MNPN-N 106 sets the Called Party Address (CdPA) to an address of MNPN-S 114. In an embodiment of the present invention, the address of MNPN-S 114 is a global title of MNPN-S 114. In another embodiment of the present invention, the address of MNPN-S 114 is a signal point code of MNPN-S 114. Thereafter, at step 1206, MNPN-S 114 sends the SCCP message for the ported-in number B to HLR-S 120. MNPN-S 114 sets the Called Party Address (CdPA) to an address of HLR-S 120. In an embodiment of the present invention, the address of HLR-S 120 is a global title of HLR-S 120. In another embodiment of the present invention, the address of HLR-S 120 is a signal point code of HLR-S 120. Finally, at step 1208, HLR-S 120 sends the IMSI associated with the ported-in number B in second network 104 (IMSI-B-S), and other information to INE 1201 using an SCCP message. In an embodiment of the present invention, INE 1201 sends a Send IMSI message, SendIMSI(B), instead of the SCCP message.

The present invention can take the form of an entirely hardware embodiment, an entirely software embodiment, or an embodiment containing both hardware and software elements. In accordance with an embodiment of the present invention, the invention is implemented in software, which includes but is not limited to firmware, resident software, microcode, etc.

Furthermore, the invention can take the form of a computer program product, accessible from a computer-usable or computer-readable medium, providing program code for use by, or in connection with, a computer or any instruction execution system. For the purposes of this description, a computer-usable or computer readable medium can be any apparatus that can contain, store, communicate, propagate, or transport the program for use by, or in connection with, the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk—read only memory (CDROM), compact disk—read/write (CD-R/W), and Digital Versatile Disk (DVD).

A computer usable medium provided herein includes computer usable program code, which when executed, receives a first query for ported-out numbers from a first HLR at a first MNPN. The computer usable medium further includes computer usable program code for receiving a second query for ported-in numbers from a GMSC at a second MNPN.

The MNPS provides mobile number portability without the need of upgrading network/system elements. The MNPS only configures some network elements. Furthermore, the MNPS avoids signaling overhead for non-ported numbers. The MNPS caters to both: ported-out and ported-in numbers. Furthermore, the MNPS allows a service provider to implement the MNPS for providing mobile number portability, for ported-out numbers only, or for ported-in numbers only. Further, the MNPS facilitates call related services as well as non call-related services, for both: ported-out and ported-in numbers.

The components of MNPS described above include any combination of computing components and devices operating together. The components of the MNPSS can also be components or subsystems within a larger computer system or network. The MNPS components can also be coupled with any number of other components (not shown), for example, other buses, controllers, memory devices, and data input/output devices, in any number of combinations. In addition, any number or combination of other processor-based components may be carrying out the functions of the MNPS.

It should be noted that the various components disclosed herein may be described using computer aided design tools, and/or expressed (or represented) as data and/or instructions, embodied in various computer-readable media, in terms of their behavioral, register transfer, logic component, transistor, layout geometries, and/or other characteristics. Computer-readable media, in which such formatted data and/or instructions may be embodied, include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole, and not to any particular portions of this application. When the word “or” is used in reference to a list of two or more items, that word covers all of the following interpretations of the word: any of the items in the list, all of the items in the list, and any combination of the items in the list.

The above description of illustrated embodiments of the MNPS is not intended to be exhaustive or to limit the MNPS to the precise form disclosed. While specific embodiments of, and examples for, the MNPS are described herein for illustrative purposes, various equivalent modifications are possible within the scope of the MNPS, as those skilled in the art will recognize. The teachings of the MNPS provided herein can be applied to other processing systems and methods. They may not be limited to the systems and methods described above.

The elements and acts of the various embodiments described above can be combined to provide further embodiments. These and other changes can be made to the MNPS in light of the above detailed description.

Other Variations

Provided above for the edification of those of ordinary skill in the art, and not as a limitation on the scope of the invention, are detailed illustrations of a scheme for providing mobile number portability. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the present invention Mobile Number Portability System (MNPS) detailed in the illustrative examples contained herein are described using terms and constructs drawn largely from GSM mobile telephony infrastructure. However, use of these examples should not be interpreted as limiting the invention to those media. Mobile Number Portability System—a method for providing mobile number portability for numbers ported from a first network to a second network can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the MNPS under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

### Technical References

GSM 902 on MAP specification

Digital cellular telecommunications system (Phase 2+);

Mobile Application Part (MAP) Specification

(3GPP TS 09.02 version 7.9.0 Release 1998)

GSM 340 on SMS

Digital cellular telecommunications system (Phase 2+);

Technical realization of the Short Message Service (SMS);

(GSM 03.40 version 7.4.0 Release 1998)

GSM 378 on CAMEL

Digital cellular telecommunications system (Phase 2+);

Customized Applications for Mobile network Enhanced Logic (CAMEL) Phase 2;

Stage 2

(GSM 03.78 version 6.7.0 Release 1997)

GSM 978 on CAMEL Application protocol

Digital cellular telecommunications system (Phase 2+);

Customized Applications for Mobile network Enhanced Logic (CAMEL);

CAMEL Application Part (CAP) specification

(GSM 09.78 version 7.1.0 Release 1998)

Signalling procedures and the Mobile Application Part (MAP) (Release 1999)

Q1214-Q1218 On Intelligent Networks

Q701-704 on SS7 MTP

Q711-Q714 on SS7 SCCP

| Acronym | Description |
|---|---|
| 3G | Third generation of mobile |
| ANSI-41 | American National Standards Institute #41 |
| ATI | Any Time Interrogation |
| BSC | Base Station Controller |
| BCSM | Basic Call State Model |
| CAMEL | Customized Application for Mobile Enhanced |
| | Logic |
| CDMA | Code Division Multiplexed Access |
| CLI | Calling Line Identification |
| CgPA | Calling Party Address |
| CdPA | Called Party Address |
| CAP | Camel Application Part |
| CC | Country Code |
| CB | Call Barring |
| CSI | Camel Subscription Information |
| DPC | Destination Point Code |
| GMSC | Gateway MSC |
| GMSC-N | GMSC in number range holder network |
| GMSC-S | GMSC in subscription network |
| GPRS | General Packet Radio System |
| GLR | Gateway Location Register |
| GSM | Global System for Mobile |
| gsmSCF | GSM Service Control Function |
| GSM SSF | GSM Service Switching Function |
| GT | Global Title |
| HLR -H | HLR from HPMN |
| HLR | Home Location Register |
| HLR-N | HLR in number range holder network |
| HLR-S | HLR in subscription network |
| HPMN | Home Public Mobile Network |
| IMSI | International Mobile Subscriber Identity |
| IMSI-B-N | IMSI for ported number B in number range |
| | holder network |
| IMSI-B-S | IMSI for ported number B in subscription |
| | network |
| IN | Intelligent Network |
| INE | Interrogating Network Entity |
| ISG | International Signal Gateway |
| INAP | Intelligent Network Application Part |
| ISD | MAP Insert Subscriber Data |
| IAM | Initial Address Message |
| IDP | Initial DP IN/CAP message |
| ITR | Inbound Traffic Redirection |
| ISUP | ISDN User Part |
| LU | Location Update |
| LUP | MAP Location Update |
| MAP | Mobile Application Part |
| MCC | Mobile Country Code |
| MCC | Mobile Country Code |
| ME | Mobile Equipment |
| MNC | Mobile Network Code |
| MNP | Mobile Number Portability |
| MNPDB | Mobile Number Portability Database |
| MNPDB-N | MNPDB in number range holder network |
| MNPDB-S | MNPDB in subscription network |
| MNPN | Mobile Number Portability Node |
| MNPN-N | MNPN in number range holder network |
| MNPN-S | MNPN in subscription network |
| MNPS | Mobile Number Portability System |
| MO | Mobile Originated |
| MSC | Mobile Switching Center |
| MSISDN | Mobile Subscriber ISDN Number |
| MSRN | Mobile Subscriber Roaming Number |
| MT | Mobile Terminated |
| MTP | Message Transfer Part |
| NP | Numbering Plan |
| NPI | Numbering Plan Indicator |
| NDC | National Dialing Code |
| ODB | Operator Determined Barring |
| OTA | Over The Air |
| O-CSI | Originating CAMEL Subscription Information |
| PRN | Provide Roaming Number |
| PSI | Provide Subscriber Information |
| RNA | Roaming Not Allowed |
| RR | Roaming Restricted due to unsupported |
| | feature |
| RI | Routing Indicator |
| SPC | Signal Point Code |
| SRI | Send Routing Information |
| SCCP | Signal Connection Control part |
| SGSN | Serving GPRS Support Node |
| SMS | Short Message Service |
| SMSC | Short Message Service Center |
| STP | Signal Transfer Point |
| STP-H | HPMN STP |
| SRI-SM | Send Routing Information For Short Message |
| SS7 | Signaling System #7 |
| SSP | Service Switch Point |
| SSN | Sub System Number |
| SIM | Subscriber Identify Module |
| STK | SIM Tool Kit Application |
| SM-RP-UI | Short Message Relay Protocol User |
| | Information |
| STP | Signal Transfer Point |
| SS | Supplementary Services |
| TR | Traffic Redirection |
| T-CSI | Terminating CAMEL Service Information |
| TCAP | Transaction Capabilities Application Part |
| TP | SMS Transport Protocol |
| UDHI | User Data Header Indicator |
| UDH | User Data Header |
| UD | User Data |
| VAS | Value Added Service |
| VLR - V | VLR from VPMN |
| VLR | Visited Location Register |
| VMSC | Visited Mobile Switching Center |
| VPMN | Visited Public Mobile Network |

We claim:

1. A system for providing mobile number portability, the system comprising:
a first Mobile Number Portability Node (MNPN), coupled to a first network, for receiving a first query for one or more ported-out numbers from a Home Location Register (HLR), wherein the HLR is coupled to the first network, the first MNPN further setting in the HLR, a location information entry corresponding to each of the ported-out numbers to an address of the first MNPN.

2. The system of claim 1, wherein the first network is a number range holder network

3. The system of claim 1, wherein the location information entry comprises a Visited Location Register (VLR) address, a Visited Mobile Switching center (VMSC) address and a Serving General packet radio services Support Node (SGSN) address.

4. The system of claim 1, wherein the address of the first MNPN is a global title of the first MNPN.

5. The system of claim 1, wherein the address of the first MNPN is a signal point code of the first MNPN.

6. The system of claim 1, further comprising: a first Mobile Number Portability Database (MNPDB) for storing routing information for each of the ported-out numbers, wherein the first MNPDB is coupled to the first network.

7. The system of claim 1, wherein the first MNPN further exchanges one or more messages between the first network and a second network for redelivering a short message service intended for the ported-out numbers upon failure of delivery of the short message service.

8. The system of claim 1, wherein the first MNPN communicates with the HLR using a standard protocol, wherein the standard protocol includes at least one of a Mobile Application Part (MAP) protocol, an Integrated Services digital network User Part (ISUP) protocol and an American National Standards Institute #41 (ANSI-41) protocol.

9. The system of claim 1, further comprising: a second MNPN, coupled to a second network, for receiving a second query for one or more ported-in numbers from a Gateway Mobile Switching Center (GMSC), wherein the GMSC is coupled to the second network.

10. The system of claim 9, wherein the second network is a subscription network.

11. The system of claim 9, further comprising: a second MNPDB for storing routing information for each of the ported-in numbers, wherein the second MNPDB is coupled to the second network.

12. The system of claim 9, wherein the second MNPN communicates with the GMSC using a standard protocol, wherein the standard protocol includes at least one of a Mobile Application Part (MAP) protocol, an Integrated Services digital network User Part (ISUP) protocol and an American National Standards Institute #41 (ANSI-41) protocol.

13. A system for providing mobile number portability, the system comprising:
a Mobile Number Portability Node (MNPN), coupled to a second network, for receiving a query for one or more ported-in numbers from a Gateway Mobile Switching Center (GMSC), wherein the GMSC is coupled to the second network.

14. A method for providing mobile number portability, the method comprising:
receiving at a first Mobile Number Portability Node (MNPN), a first query for one or more ported-out numbers from a first Home Location Register (HLR), wherein the first MNPN and the first HLR are coupled to a first network.

15. The method of claim 14, wherein the first network is a number range holder network.

16. The method of claim 14, further comprising: setting in the first HLR, a location information entry corresponding to each of the ported-out numbers to an address of the first MNPN.

17. The method of claim 16, wherein the location information entry comprises a Visited Location Register (VLR) address, a Visited Mobile Switching Center (VMSC) address and a Serving General packet radio services Support Node (SGSN) address.

18. The method of claim 16, wherein the address of the first MNPN is a global title of the first MNPN.

19. The method of claim 16, wherein the address of the first MNPN is a signal point code of the first MNPN.

20. The method of claim 14, further comprising: receiving a third query for the ported-out numbers at the first MNPN, wherein the third query is a short message service related query.

21. The method of claim 14, further comprising: querying one of a second MNPN and a second HLR, upon receipt of the first query for the ported-out numbers at the first MNPN, wherein the second MNPN and the second HLR are coupled to a second network.

22. The method of claim 14, wherein the first MNPN further exchanges one or more messages with the first network and a second network for redelivering a short message service intended for the ported-out numbers upon failure of delivery of the short message service.

23. The method of claim 14, wherein the first MNPN communicates with the first HLR using a standard protocol, wherein the standard protocol includes at least one of a Mobile Application Part (MAP) protocol, an Integrated Services digital network User Part (ISUP) protocol and an American National Standards Institute #41 (ANSI-41) protocol.

24. The method of claim 14, further comprising: receiving at a second MNPN, a second query for one or more ported-in numbers from a Gateway Mobile Switching Center (GMSC), wherein the second MNPN and the GMSC are coupled to a second network.

25. The method of claim 24, wherein the second network is a subscription network.

26. The method of claim 24, further comprising: receiving a fourth query for the ported-in numbers at the second MNPN from the first MNPN.

27. The method of claim 24, wherein the second MNPN communicates with the GMSC using a standard protocol, wherein the standard protocol includes at least one of a Mobile Application Part (MAP) protocol, an Integrated Services digital network User Part (ISUP) protocol and an American National Standards Institute #41 (ANSI-41) protocol.

28. A computer program product comprising a computer usable medium including a computer usable program code for providing mobile number portability, the computer program product comprising:
computer usable program code for receiving at a first Mobile Number Portability Node (MNPN), a first query for one or more ported-out numbers from a first Home Location Register (HLR), wherein the first MNPN and the first HLR are coupled to a first network.

29. The computer program product of claim 28, further comprising: computer usable program code for setting in the first HLR, a location information entry corresponding to each of the ported-out numbers to an address of the first MNPN.

30. The computer program product of claim 28, further comprising: computer usable program code for receiving a third query for the ported-out numbers at the first MNPN.

31. The computer program product of claim 28, further comprising: computer usable program code for querying one of a second MNPN, coupled to a second network, and a second HLR, coupled to the second network.

32. The computer program product of claim 28 further comprising computer usable program code for exchanging one or more messages with the first network and a second network through the first MNPN for redelivering a short message service intended for the ported-out numbers upon failure of delivery of the short message service.

33. The computer program product of claim 28, further comprising: computer usable program code for receiving at a second MNPN, a second query for one or more ported-in numbers from a Gateway Mobile Switching Center (GMSC), wherein the second MNPN and the GMSC are coupled to a second network.

34. The computer program product of claim 33, further comprising: computer usable program code for receiving a fourth query for the ported-in numbers at the second MNPN from the first MNPN.
